(19) United States
(12) Patent Application Publication
(10) Pub. No.: US 2005/0188859 A1
(43) Pub. Date: Sep. 1, 2005

(54) Production meat analysis system and method

(75) Inventors: Frank M. Bruce III, Wauwatosa, WI (US); Jason W. Wermers, Brown Deer, WI (US); Donald J. Olson, Brookfield, WI (US); John C. St. Onge, Waukesha, WI (US)

Correspondence Address: JOSEPH S. HEINO, ESQ.;DAVIS & KUELTHAU, S.C., 111 E. KILBOURN, SUITE 1400, MILWAUKEE, WI, 53202-6613, US

(73) Assignee: The Enhancers, Inc., Menomonee Falls, WI (US)

(21) Appl. No.: 10/983,370

(22) Filed: Nov. 8, 2004

Related U.S. Application Data
(60) Provisional application No. 60/549,079, filed on Mar. 1, 2004.

(51) Int. Cl. A23C 19/00

(52) U.S. Cl. 99/486

(57) ABSTRACT

A production meat analysis system and method provides means for determining percent or absolute constituents of a production lot of ground meat product immediately following the meat pre-grinding process. During use, the system is located at the output of a production meat pre-grinder such that the ground meat passes over the belt of the weigh conveyor and through the detection field or range of the NIR sensor. During this process, constituent readings for fat, moisture, protein and temperature are recorded for each unit weight pulse. The cumulative weighted average for each constituent is calculated for each unit weight and recorded and displayed on the computer screen as the process continues without stoppage or interruption. Constituent content can thereby be manually or automatically adjusted.

### PRODUCTION MEAT ANALYSIS SYSTEM AND METHOD

This Application claims the benefit of U.S. Provisional Application No. 60/549,079, filed Mar. 1, 2004.

### FIELD OF THE INVENTION

This invention relates generally to methods and devices used in the meat production industry. More particularly, it relates to a system and method for accurately measuring certain production information relative to the production and processing of ground meat products. It also relates to a system and method that visually displays that information for the beneficial use of meat producers.

### BACKGROUND OF THE INVENTION

In the meat production industry, accurate and automatic in-line fat analysis technology has long been desired for the processing of ground meat. In the experience of these inventors, producers of ground meat currently must halt production at regular intervals so that ground meat samples can undergo laboratory analysis to determine the ratio of fat-to-lean in the ground meat product that is being produced. This type of sampling decreases the overall efficiency of a production line and increases operating costs. Time consuming adjustments also must be made periodically, which adjustments further decrease production line efficiency. Moreover, accuracy suffers since line sampling is a relatively inaccurate way to determine quality of a non-homogeneous product, a product that can change dramatically in quality in a very short period of time. Such sampling is absolutely required in order to verify the fat content of incoming meat trimmings and to verify the fat content of the final ground meat product. What is needed is a system and method for providing accurate in-line analysis for ground meat production which eliminates the need for regular product sampling and eliminates the need to stop or slow down production.

Accordingly, it is an object of the present invention to provide a new and useful production meat analysis system and method that provides for the accurate in-line analysis of ground meat product during production. It another object of the present invention to provide such a system and method that utilizes sensors and computer algorithms to provide accurate in-line analysis for the ground meat. It is still another object of the present invention to provide such a system and method that utilizes near infrared technology to sense and measure fat, protein and moisture contents and the temperature of fresh and frozen ground meat. It is yet another object of the present invention to provide such a system and method that provides for such sensing with non-contact technology and which is insensitive to ambient lighting, relative humidity, temperature and pass height variations. It is still another object of the present invention to provide such a system and method that provides for fast and stable drift-free operation. It is yet another object of the present invention to provide such a system and method that requires a minimal number of elements and a minimal number of steps to utilize. It is still another object of the system and method of the present invention to provide such a system that incorporates a visual display for the user, which display provides the user with critical real-time information as well as historical data concerning ground meat production for any given batch.

### SUMMARY OF THE INVENTION

The production meat analysis system and method of the present invention has obtained these objects. It provides for a calibrated near infrared (NIR) spectroscopic sensor that is capable of providing electronic data signals that are proportional to the percentages of fat, moisture, and protein, as well as temperature, of a batch as measured by the sensor at any instant in time. It also provides for a weigh conveyor situated below the sensor and having a load cell and position encoder that are capable of providing a calibrated electronic pulse for every unit of weight passing over the conveyor belt. It also provides for a computer having the capability to accept data inputs from the weigh conveyor and spectroscopic sensor and running a software program that continuously calculates the accumulated weighted average of the instantaneous constituent measurements.

The system and method of the present invention provides a means for determining the percentage fat contained in a production lot of ground meat product immediately following the meat pre-grinding process. During use, the system is located at the output of a production meat pre-grinder such that the ground meat passes over the belt of the weigh conveyor and through the detection field or range of the NIR sensor. During this process, percent constituent readings for fat, moisture and protein are recorded for each unit weight pulse. The cumulative weighted average for each constituent is calculated for each unit weight and recorded and displayed on the computer screen as the process continues without stoppage or interruption.

The system and method of the present invention also provides a means for determining the temperature of the ground meat product immediately following the meat pre-grinding process, and as it passes over the belt of the weigh conveyor and through the detection field or range of the NIR sensor. During this process, the temperature can be recorded for each unit weight pulse as the meat product continues to be conveyed to a mixer. In some applications, it is necessary to chill the meat product to a certain temperature to aid in the mixing process and in the forming process following mixing. Chilling is typically accomplished by CO₂ injection of the meat product at the input end of the mixer. This cools the meat product to a desired temperature. The amount of CO₂ injection required depends, however, upon the upstream temperature and composition of the meat product. If the meat product is warm, greater amounts of CO₂ injection will be required. If the meat product is relatively cold, less amounts of CO₂ injection will be required. The apparatus of the present invention can be used to optimize, and thus conserve, the amount of CO₂ injection required on a near-instantaneous basis as the process continues without stoppage or interruption. The same apparatus and method can be used when adding steam and pressure to cook the meat product, thus optimizing heating and pressure requirements and energy consumption in the same fashion.

The foregoing and other features of the present invention will be apparent from the detailed description that follows.

### BRIEF DESCRIPTION OF THE DRAWINGS

FIG. 1 is a perspective view of a production meat analysis system, including a calibrated NIR sensor, a weigh conveyor and a computer and display module, all constructed in accordance with the present invention.

FIG. 2 is an enlarged and partially sectioned perspective view of the weigh conveyor portion of the system shown in FIG. 1.

FIG. 3 is schematic diagram of the system shown in FIG. 1.

FIG. 4 is a graphical representation of a batch run that uses the system and method of the present invention.

FIG. 5 is a further enlarged representation of the display monitor shown in FIG. 1.

FIG. 6 is the setup screen option as it would be displayed on the monitor shown in FIGS. 1 and 5.

FIG. 7 is the diagnostic screen option as it would be displayed on the monitor shown in FIGS. 1 and 5.

FIG. 8 is a system schematics screen option as it would be displayed on the monitor shown in FIGS. 1 and 5.

FIG. 9 is an alarm screen option as it would be displayed on the monitor shown in FIGS. 1 and 5.

### DETAILED DESCRIPTION

As alluded to earlier, the fat content of a production batch of ground meat has traditionally been determined by stopping the grinding process such that a line worker can take a small sample of ground meat for laboratory analysis. The time that is necessary to process the sample in the lab can take several minutes during which the production process must wait for the lab results before production can be resumed and corrective action taken to insure that the final composition of the batch will meet specifications for percentage fat. Use of the system and method of the present invention allows the production grinding of ground meat to continue without interruption. In the experience of these inventors, this significantly increases the amount of ground meat that can be produced during a given time on a production line.

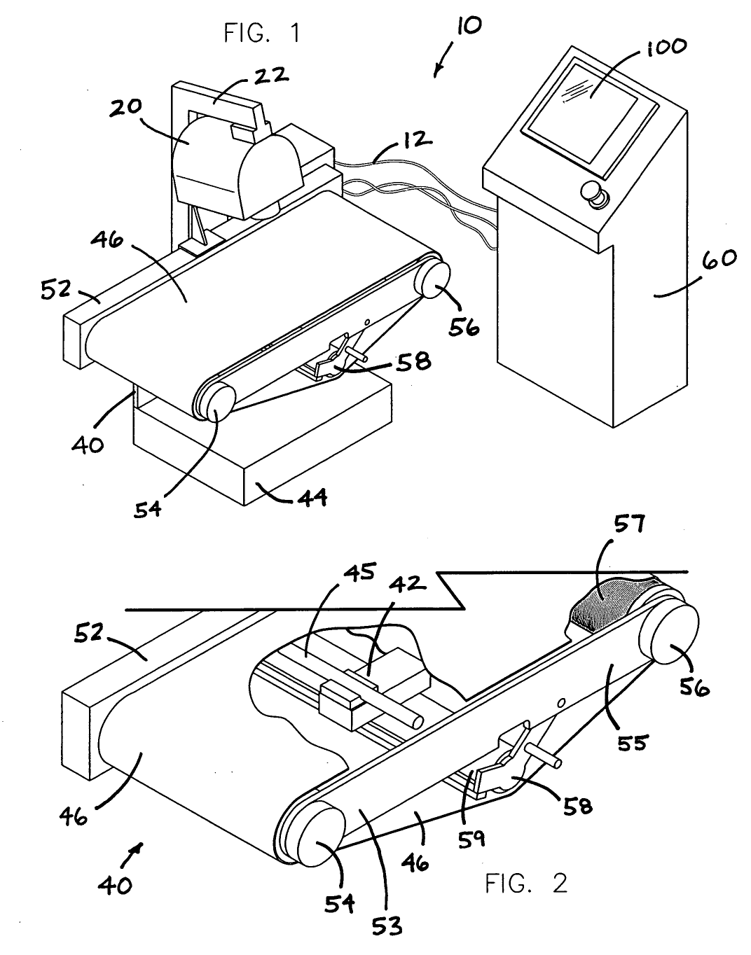

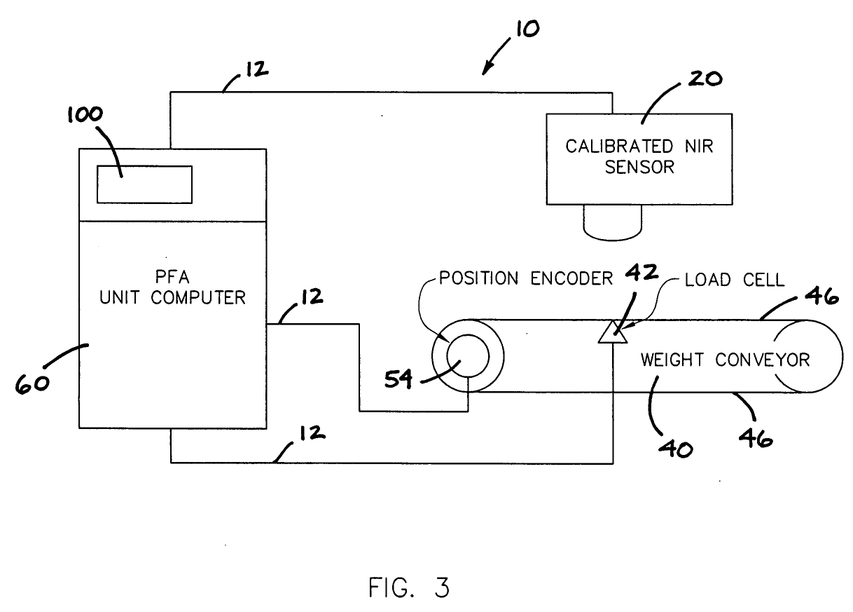

Referring now to the drawings in detail wherein like numbers represent like elements throughout, FIG. 1 illustrates a perspective view of one embodiment of the production meat analysis system, generally identified 10, constructed in accordance with the present invention. This system is also depicted schematically in FIG. 3. As shown, the system 10 includes a calibrated near infrared (NIR) sensor 20 capable of providing electronic data signals proportional to the percentage fat, moisture, protein and temperature as measured by the sensor 20 at any instant in time. It also includes a weigh conveyor 40 having a load cell 42 and position encoder 44 capable of providing a calibrated electronic pulse for every unit of weight passing over the conveyor belt 46. And it includes a computer 60 having the capability to accept data inputs from the weigh conveyor 40 and spectroscopic sensor 20, running a software program that continuously calculates the accumulated weighted average of the instantaneous constituent measurements. The computer 60 also includes a display monitor 100 for displaying these calculations and other relevant production information.

Referring again specifically to FIG. 1, it will be seen that the NIR sensor 20 is mounted generally above the conveyor belt 46 in such a way that ground meat situated on the belt 46 passes under the sensor 20. Specifically, a sensor support member 22 is connected to and extends upwardly from one side of the weigh conveyor frame 52. In the preferred embodiment, the sensor 20 is designed and calibrated specifically for meat measurements. In addition to fat, the sensor 20 simultaneously detects moisture, protein and temperature. The sensor 20 is a non-contact device that works by projecting a 2.4 inch NIR light beam downwardly onto the surface of the meat that flows beneath it from a pre-grinder (not shown). In the preferred embodiment, the sensor 20 utilizes a dual detector optical system. Internally, the sensor includes a source lamp and an off-axis collecting mirror to reflect light back through the sensor 20. A motor-driven filter wheel, rotating at 8,000 rotations per minute, directs the light to a beam splitter. A primary and a secondary detector are provided. In this way, a sensor gauge is continuously monitored by the secondary detector. And the ratio of the secondary to primary detector, wavelength by wavelength, eliminates the influence of the gauge. Essentially, the sensor 20 measures the characteristics of the back-scattered light that emanates from the surface of the meat product. A sampling rate of 7,500 times per minute is used. The sensor 20 is self-compensating so it is unaffected by ambient lighting and requires no adjustment. The electrical signal output from the sensor 20 provides simultaneous fat, moisture, protein and temperature signals to the computer 60. The sensor 20 is contained within a housing for severe wash-down conditions which are common in the meat processing industry.

The weigh conveyor 40 includes a conveyor frame 52. See also FIG. 2. The conveyor frame 52 is supported by a frame base 44 and has a first end 53 and a second end 55. Rotatably mounted to the first end 53 of the conveyor frame 52 is a position encoder roller 54. Rotatably mounted to the second end 55 of the conveyor frame 52 is a drive roller 56. The drive roller 56 has a knurled surface 57 so as to provide a friction surface for the inside portion of the belt 46. A tensioning roller 58 is also provided and which is mounted to the underside 59 of the conveyor frame 52. This tensioning roller 58 provides automatic belt tightening capabilities for the weigh conveyor belt 46. The weigh conveyor 40 also includes a load cell 42 and a load cell bar 45. The load cell bar 45 extends perpendicularly across the belt 46 and across its path of travel. In this way, product passing along the belt 46 at the point of the load cell 42 exerts a downward pressure on the bar 45 and the load cell 42 thereby registering an instantaneous batch weight measurement. The weigh conveyor 40 and its various component parts are also fabricated and assembled for severe wash-down conditions as previously described.

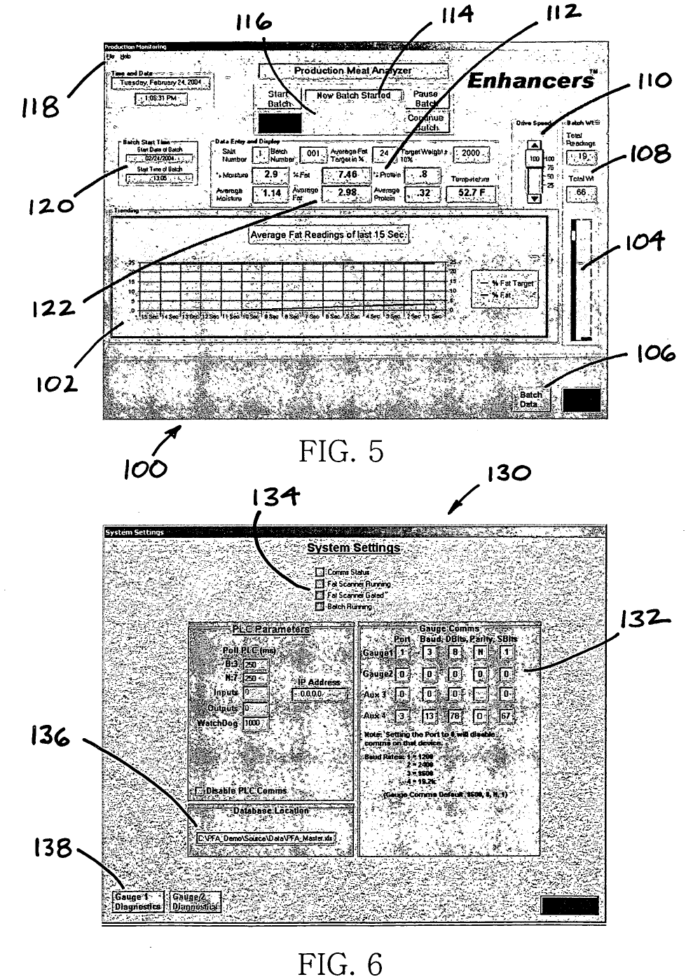

The computer 60, which is connected to the NIR sensor 20 and the weigh conveyor 40 by means of a plurality of electrical cables 12 as shown in FIG. 1, calculates batch weighted averages and displays the results. As shown in FIG. 5, the system display monitor 100 shows the operator critical real time information and records the date and time, the shift and batch identifiers, instantaneous and average levels for fat percentage, moisture percentage and protein percentage. Also displayed is the weight, temperature and batch targets by percentage fat and weight. Because the percent fat content is constantly calculated and displayed by the computer monitor 100, fat content of the product can be held to much closer tolerances. Using the calculated cumulative weighted average fat content as feedback during production, fat content for the batch being produced can be manually or automatically adjusted as grinding progresses, until a specified batch weight and fat content are produced.

During the typical meat grinding process, and depending on feed rates and the types of material being fed into the pre-grinder, the ground meat exiting the pre-grinder may be produced irregularly in clumps, with more or less mass flowing from the grinding apparatus at any given time. Because of this phenomenon, simple averaging of instantaneous measurements of constituent readings for fat, moisture and protein will not provide accurate measurements for the production batch. The system 10 and method of the present invention solves this problem by incorporating the mass flow, as provided by the unit weight pulses from the weigh conveyor, into the calculation, thus providing accurate results.

In application, the system 10 is located at the output end of a production meat pre-grinder such that the ground meat passes over the belt 46 of the weigh conveyor 40 and through the detection range of the NIR sensor 20. During this process, percent constituent readings for fat, moisture and protein, as well as temperature, are recorded for each unit weight pulse. The cumulative weighted average for each constituent is calculated for each unit weight and is recorded and displayed on the computer screen 100 as the process continues. The composition equation is as follows:

Base Equation:

$${X}_{c} = ( ( {\sum }_{B0}^{Bx} ( Wi * Ci ) / ( {\sum }_{B0}^{Bx} Wi ) ) * 100$$

Wherein X_{c}=Component Percentage (fat percentage, moisture percentage, protein percentage, temperature)
B₀=Batch Start Time
Bₓ=Batch End Time
Cᵢ=Instantaneous Calibrated NIR Gauge Value—Rolling average (fat, moisture, protein, temperature)
Wᵢ=Instantaneous Weight from Load Cell Calculations of the value for each component X_{c} (fat, moisture, protein, and temperature) are calculated individually. The calculations are the summations of individual slices of data across a time period of B₀ to Bₓ. This time period defines one batch and is the basis of production in the meat industry.

Each slice of the summation is calculated from inputs from the weighing system 10 and gauge, which results in a weight corrected composition value for each component. Information from the gauge is collected, and a rolling average for each channel created. The duration during which the rolling average C is created is equal to the weighing system response time. This rolling average C is representative of the composition of the material passing the gauge during the given time period. This value C is then multiplied by the weight value for the time period resulting in a weight corrected composition percentage for the slice.

As previously discussed, the system 10 is controlled through the use of an industrial computer 60 with touch screen 100. The control software is a custom application developed to operate in a Windows® environment. All system control and data logging is made available to the operator through the use of a simple push button interface 100.

The main screen 100 provides all control and status information required for normal operation. This screen is illustrated in FIG. 5. As shown, the main screen 100 includes a trend chart 102 that provides a graphical representation of the target fat percentage for the batch and the current fat percentage of the batch with a 15 second history. It also includes a batch fill level indicator 104 that provides a graphical representation of the target batch size and the current fill level updated in real time. A batch data button 106 is provided to allow the operator access to the current day's production history. The display 100 also includes an accumulated batch weight display 108, a speed control slider 110, a batch status display 114 and operator push buttons 116. Further provided are the displays for the instantaneous and batch composition values 112, which is the Equation Cᵢ, the batch average composition 122, which is the Equation X_{c}, and the batch start date and time 120, which is the Equation B₀. A “Help” and “File” pull-down menu 118 is also provided. This menu 118 allows the operator to navigate to the system setup and configuration page or to exit the application to the Windows® operating environment.

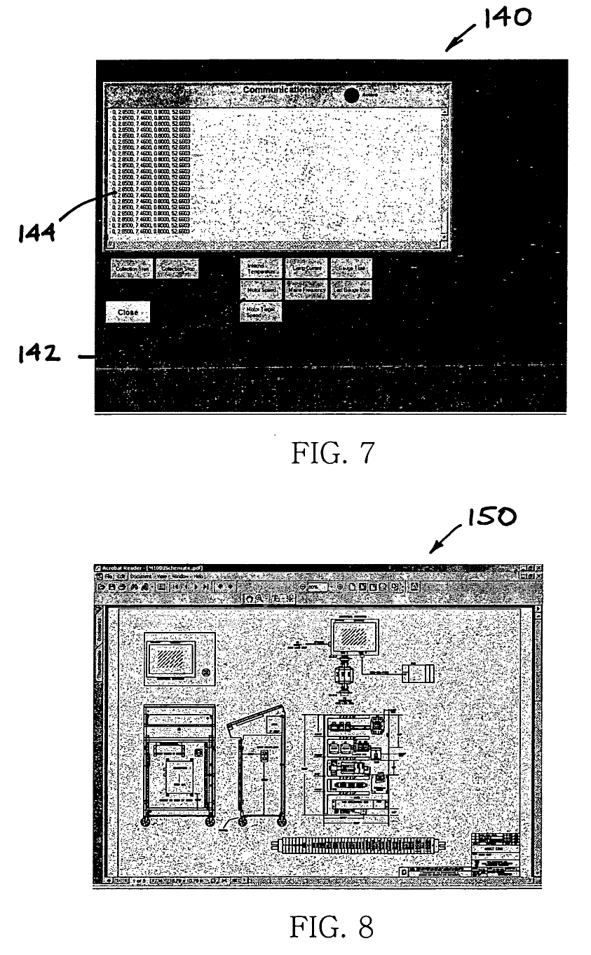

As shown in FIG. 6, the setup screen 130 is displayed. This display includes the communications settings 132 for the gauge which provides the ability for the system to address multiple gauge settings or to adapt to changes in the overall hardware configuration of the system 10. Also included is a communications status display 134 and a database location display 136 which allows for the local or remote storage of all database information, also known as the historical batch composition data. A gauge diagnostics button 138 is provided which provides access to the display 140 illustrated in FIG. 7, which is the diagnostic screen display. As shown, the diagnostics screen 140 includes a number of diagnostic request push buttons 142 which query the gauge for current set point and status information. This provides detailed operational information for trouble shooting and support including internal temperature, lamp current, gauge time, motor speed, frequency, last boot and target speed. The communications window 144 displays information received from the gauge during operation and diagnostics.

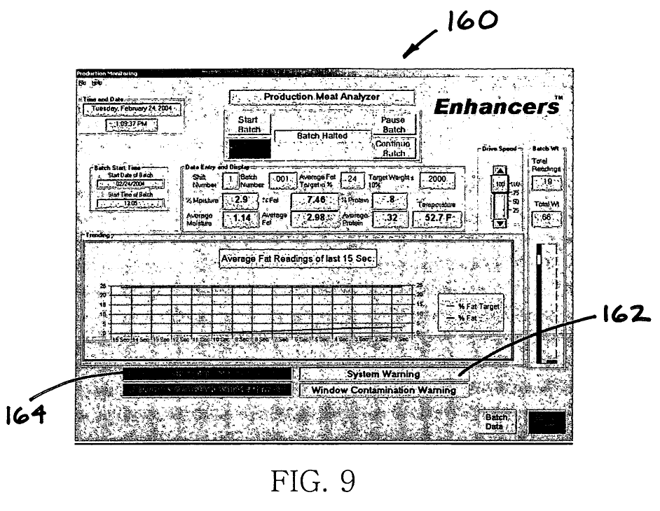

As shown in FIG. 8, a system schematics display 150 is provided. In the main screen display 100, provision is also made for system failure and system warning alarms. See FIG. 9. As shown, the alarm display screen 160 provides the system warning alarm 162 and the system failure alarm 164 towards the bottom of the screen display. The system warning alarm 162 will activate when system operation is possible, but degraded. For example, the warning alarm 162 may activate when there is contamination of the window of the sensor 20. That is, the gauge window is dirty and needs to be cleaned as soon as possible. It may also activate when the gauge is operating below or above minimum or maximum operating temperatures, respectively. It may also activate when there is too much signal or too little signal being received by the sensor 20 in the case where batch material is too close to the gauge or too far away from it, respectively. The system failure alarm 164 may activate when the sensor 20 window is contaminated to the point that reliable readings cannot be collected, or where the internal gauge temperature has exceeded the maximum operating temperature. It may also activate when the motor spinning the filter wheel has failed, when the lamp is using too little or too much current based on design specifications, or when the lamp voltage is outside of the acceptable operating range.

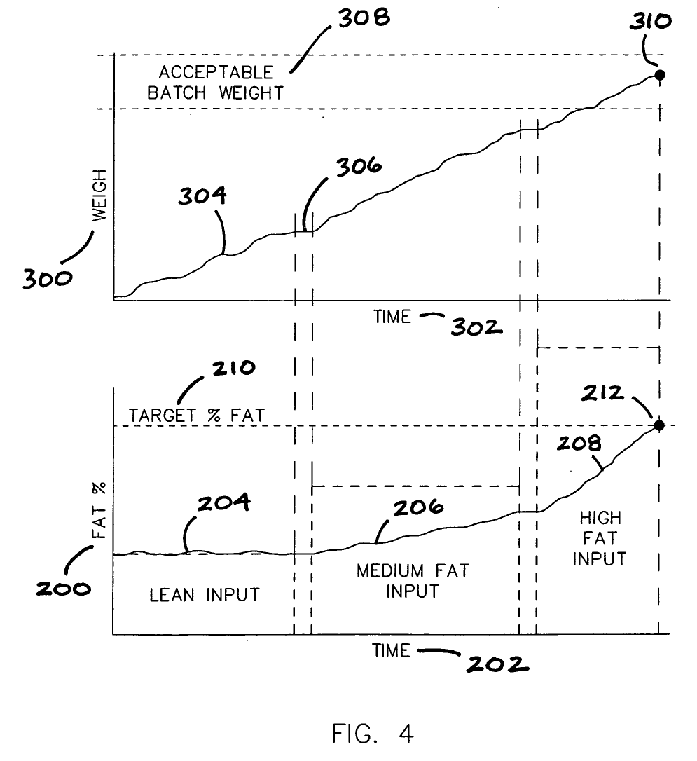

To produce a finished batch of ground meat, operators observe the computer display 100 during the pre-grind process, starting with leaner trimmings and then adjusting batch fat content as target weight is approached by adding higher fat trimmings until the computer display 100 shows that fat target and weight targets have been met. This concept is illustrated in FIG. 4. In the bottom chart, which illustrates the fat percentage 200 as a function of time 202, a target percentage of fat 210 is determined. Initial input 204 to the pre-grinder is relatively lean. As time goes by, and ground meat product batch continues to accumulate, medium fat content meat is added 206. Between these batch changes, it should be noted that the total batch weight 306 remains the same as shown in the upper chart. The upper chart illustrates the accumulated batch weight 300 as a function of time 302. As the total batch weight 304 begins to approach the acceptable batch weight target 308, 310, high fat meat is inputted 208 to the pre-grinder to reach the target percentage of overall fat content 210, 212 and the acceptable batch weight 308. Following the pre-grind, the beef is cooled by CO₂ injection, mixed and final ground before being formed into patties and the like. In the experience of these inventors, this system 10 provides outstanding batch results without lab analysis and has zero down time for system failures and recalibration.

As alluded to above, the system 10 and method of the present invention provides a means for determining the temperature of the production lot of ground meat product immediately following the meat pre-grinding process. That is, the system 10 is located at the output of a production meat pre-grinder such that the ground meat passes over the belt 46 of the weigh conveyor 40 and through the detection field or range of the NIR sensor 20. During this process, the temperature of the meat product can be recorded for each unit weight pulse as the meat product continues to be conveyed to a mixer (not shown). In some applications, it is necessary to chill the meat product to a certain temperature to aid in the mixing process and the forming process that typically follows the mixing process. Chilling is typically accomplished by CO₂ injection of the meat product at the mixer input. This cools the meat product to a desired temperature as it mixes. The amount of CO₂ injection required depends, however, upon the upstream temperature and composition of the meat. If the meat product is warm, greater amounts of CO₂ injection are required. If the meat product is relatively cold, less amounts of CO₂ injection are required. The apparatus of the present invention can be used to optimize, and thus conserve, the amount of CO₂ injection required. The same apparatus and method can also be used when adding steam and pressure to cook the meat product, thus optimizing heating and pressure requirements in a similar fashion.

Based upon the foregoing, it will be seen that there has been provided a new and useful production meat analysis system and method that provides for accurate in-line analysis of ground meat product during production; that utilizes sensors and computer algorithms to provide accurate in-line analysis for the ground meat; that utilizes near infrared technology to sense and measure fat, protein and moisture contents and the temperature of fresh and frozen ground meat; that provides for such sensing with non-contact technology and which is insensitive to ambient lighting, relative humidity, temperature and pass height variations; that provides for fast and stable drift-free operation; that requires a minimal number of elements and a minimal number of steps to utilize; and that incorporates a visual display for the operator, which display provides the operator with critical real-time information concerning ground meat production for any given batch.

1. A production meat analysis system which comprises
a calibrated near infrared spectroscopic sensor, such sensor being capable of providing instantaneous electronic data signals for constituent measurements of a meat batch,
a weigh conveyor situated below the sensor and having a load cell and position encoder that are capable of providing a calibrated electronic pulse for a unit of weight passing over the weigh conveyor,
a computer that is capable of accepting data inputs from the weigh conveyor and from the sensor,
wherein the computer continuously calculates and records the accumulated weighted average of the instantaneous constituent measurements, and
a computer display screen for displaying the constituent measurements and calculations of the accumulated weighted averages of the measurements.

2. The system of claim 1 wherein the constituent measurements are one or more from a group comprising percentages of fat, moisture, and/or protein, and/or temperature of the meat batch.

3. The system of claim 2 wherein the constituent measurements are used to make manual or automatic adjustments to the meat batch content.

4. The system of claim 1 wherein the sensor is capable of providing electronic data signals that are proportional to the percentage fat, moisture, protein, and/or temperature as measured by the sensor at any instant in time.

5. The system of claim 4 wherein the data signals are used to make manual or automatic adjustments to the meat batch contents.

6. A production meat analysis system which comprises
a weigh conveyor, said weigh conveyor including
a frame having a first end and a second end,
a sensor support member extending upwardly from the frame,
a near infrared sensor secured to the sensor support member for recording instantaneous content readings for a meat batch,
a position encoder roller rotatably mounted to the first end of the conveyor frame,
a drive roller rotatably mounted to the second end of the conveyor frame,
a conveyor belt, the belt being rotatably mounted to the position encoder roller and to the drive roller,
a load cell and a load cell bar, the load cell bar extending generally perpendicularly across the conveyor belt such that meat product passing along the belt at the point of the load cell registers an instantaneous meat batch weight measurement,
a computer electronically connected to the sensor and the load conveyor to calculate and record batch weighted averages, and
a display monitor for displaying real time and/or average batch content information,
wherein the batch content information can be used to make manual or automatic adjustments to the batch content.

7. The assembly of claim 6 wherein the batch content information comprises one or more constituents from a group consisting of date, time, shift identifiers, batch identifiers, and instantaneous and/or average constituent levels of fat percentage, moisture percentage, protein percentage, and temperature, and/or batch targets for same.

8. The assembly of claim 7 wherein the batch weighted average for each constituent is calculated in accordance with the following base equation
$${X}_{c} = ( ( {\sum }_{B0}^{Bx} ( Wi * Ci ) / ( {\sum }_{B0}^{Bx} Wi ) ) * 100$$
wherein X_{c}=Component Percentage (fat percentage, moisture percentage, protein percentage, temperature)
B₀=Batch Start Time
Bₓ=Batch End Time
Cᵢ=Instantaneous Calibrated NIR Gauge Value—Rolling average (fat, moisture, protein, temperature)
Wᵢ=Instantaneous Weight from Load Cell

9. The assembly of claim 6 including a batch mixer and a batch cooling or heating means situated at the batch mixer and the batch content information is temperature, wherein batch meat entering the batch mixer can be cooled or heated to a target temperature depending upon the instantaneous batch meat temperature and meat composition at the sensor.

10. A method for analyzing meat production which comprises the steps of
providing a calibrated near infrared spectroscopic sensor, such sensor being capable of providing instantaneous electronic data signals for constituent measurements of a meat batch,
providing a weigh conveyor situated below the sensor and having a load cell and position encoder that are capable of providing a calibrated electronic pulse for a unit of weight passing over the weight conveyor,
providing a computer that is capable of accepting data inputs from the weigh conveyor and from the sensor,
continuously calculating and recording the accumulated weighted average of the instantaneous constituent measurements, and
providing a computer display screen for displaying the constituent measurements and calculations of the accumulated weighted averages of the measurements.

11. The method of claim 10 wherein the constituent measurements are one or more from a group comprising percentages of fat, moisture, and/or protein, and/or temperature of the meat batch.

12. The method of claim 11 wherein the constituent measurements are used to make manual or automatic adjustments to the meat batch content.

13. The method of claim 10 wherein the sensor is capable of providing electronic data signals that are proportional to the percentage fat, moisture, protein, and/or temperature as measured by the sensor at any instant in time.

14. The method of claim 13 including, following the display screen providing step, the step of using the data signals to make manual or automatic adjustments to the batch contents.

15. A production meat analysis method which comprises the steps of
providing a weigh conveyor, said weigh conveyor including
a frame having a first end and a second end,
a sensor support member extending upwardly from the frame,
a near infrared sensor secured to the sensor support member for recording instantaneous content readings for a meat batch,
a position encoder roller rotatably mounted to the first end of the conveyor frame,
a drive roller rotatably mounted to the second end of the conveyor frame,
a conveyor belt, the belt being rotatably mounted to the position encoder roller and to the drive roller,
a load cell and a load cell bar, the load cell bar extending generally perpendicularly across the conveyor belt such that meat product passing along the belt at the point of the load cell registers an instantaneous meat batch weight measurement,
electronically connecting a computer to the sensor and the load conveyor for calculating and recording batch weighted averages, and
displaying real time and/or average batch content information on a display monitor,
wherein the batch content information can be used to make manual or automatic adjustments to the batch content.

16. The method of claim 15 wherein the batch content information comprises one or more constituents from a group consisting of date, time, shift identifiers, batch identifiers, and instantaneous and/or average constituent levels of fat percentage, moisture percentage, protein percentage, and temperature, and/or batch targets for same.

17. The method of claim 16 wherein the batch weighted average for each constituent is calculated in accordance with the following base equation
$${X}_{c} = ( ( {\sum }_{B0}^{Bx} ( Wi * Ci ) / ( {\sum }_{B0}^{Bx} Wi ) ) * 100$$
wherein X_{c}=Component Percentage (fat percentage, moisture percentage, protein percentage, temperature)
B₀=Batch Start Time
Bₓ=Batch End Time
Cᵢ=Instantaneous Calibrated NIR Gauge Value—Rolling average (fat, moisture, protein, temperature)
Wᵢ=Instantaneous Weight from Load Cell

18. The method of claim 16 including, following the information displaying step, the steps of providing a batch mixer, providing a batch cooling or heating means situated at the batch mixer, and using the batch content information of temperature and meat composition to cool or heat batch meat entering the batch mixer to a target temperature.
